(19) United States
(12) Patent Application Publication
(10) Pub. No.: US 2011/0006984 A1
(43) Pub. Date: Jan. 13, 2011

(54) Optical Helmet-Position Detection Device Having a Large Dynamic Range

(75) Inventors: Jean-Noël Perbet, Eysines (FR); Bruno Barbier, Bordeaux (FR); Laurent Potin, Courtras (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/833,578

(22) Filed: Jul. 9, 2010

(30) Foreign Application Priority Data
Jul. 10, 2009 (FR) 09 03422

(51) Int. Cl. G06F 3/033

(52) U.S. Cl. 345/158

(57) ABSTRACT

The general field of the invention is that of optical devices for detecting the position/orientation of a helmet. The device according to the invention comprises an optional stationary light source, a stationary camera associated with an image processing system, and a helmet. The helmet has a scattering coating and includes at least one set of markers, each marker comprising at least a first optical element having a very low reflection coefficient, a very low scattering coefficient and a very high absorption coefficient in the visible range and in that of the light source. In one embodiment, each marker may also include a first optical element having a very high retroreflection coefficient and a very low scattering coefficient in the visible range. The marker may also include a second optical element having a high scattering or phosphorescence coefficient in the emission range of the light source.

### CROSS-REFERENCE TO RELATED APPLICATIONS

This application claims priority to foreign France patent application No. 0903422, filed on Jul. 10, 2009, the disclosure of which is hereby incorporated by reference in its entirety.

### FIELD OF THE INVENTION

The field of the invention is that of optical devices for detecting the instantaneous position and orientation of the helmet worn by an aircraft pilot. In general, in the rest of the text the term “posture” refers to a particular position and a particular orientation of the helmet. For certain aeronautical applications, the helmets of pilots are provided with display devices for generating, in the pilot's field of view, information about the flight, the navigation or the reference system. These helmet visuals are generally coupled to systems for detecting the position and orientation of the helmet.

### BACKGROUND

There are various systems for referencing the position of a helmet. In particular, systems based on the analysis of optical signals representative of the position of the helmet are used. These systems necessarily comprise one or more light emission sources and one or more light reception sources. The emission sources may, as shown in FIG. 1, be luminous markers or point sources 3 of the light-emitting diode type that are fastened to the helmet 1 in a particular arrangement, namely a triangle in FIG. 1. The position of the helmet 1 in a defined region 4 is then obtained by analyzing the images of the diodes received by cameras 2 under several points of view and the position of the head in space is deduced by geometric calculation. Such devices have been produced by the company Karl Zeiss/Denel. Alternatively, it is possible to place arrays of photosensors or photodiodes on the helmet and to illuminate them by particular image projectors so that the analysis, either spatially or temporally, of the signals received by the various photodetectors allows the information about the helmet posture to be recovered.

Whatever the method chosen, the detected signal S_{D} is disturbed by solar illumination, as indicated in FIG. 1. In this figure, the portion 11 of the solar illumination 10 is scattered by the helmet 1 towards the recognition cameras 2. It is known that solar illumination may reach 70 000 lux in the case of a cockpit glass having a transmission of 70%. The detected signal S_{D} becomes barely exploitable whenever the solar illumination received by the helmet is high, as is seen in FIG. 2 which shows on the left the signal S_{D} under low illumination, represented by a moon crescent, and on the right the signal S_{D} under high illumination represented by a sun. The signal S_{D} is given in arbitrary units and depends on a position L in the matrix of photodetectors. When the emission sources are on the helmet, their signal is drowned in the solar illumination. When the photodetectors are on the helmet, the receive signal coming from the source is drowned in the solar illumination. The means conventionally used to improve the detection consists in providing a high-power source. It is also possible to emit and receive in a wavelength range lying outside that of visible solar radiation, i.e. located either in the infrared or in the near ultraviolet. However, the solar illumination levels are still high in the infrared and ultraviolet bands, and this type of solution requires specific emission and reception sources that necessarily increase the cost of the detection system.

### SUMMARY OF THE INVENTION

The object of the device according to the invention is to produce an optical position/orientation detection system that can be used in a wide range of illuminations, in daytime with illuminations of the order of 100 000 lux and at night with illuminations of the order of 0.01 lux. Under high illumination, the invention utilizes solar illumination instead of combating it, by employing passive markers on the helmet that do not reflect the solar illumination or that reflect the solar light along an axis different from that of the optical sensors. Under low illumination, additional light sources ensure, if need be, the visibility of the markers. These markers may be bordered with a phosphorescent film emitting visible light under excitation by the additional source in the ultraviolet range.

This solution has the main advantages, compared with the prior art, of not requiring a power supply for the markers on the pilot's helmet, of being particularly simple and robust, and of giving signal/noise ratios that are always high irrespective of the illumination. It is therefore perfectly suited to the environment of aircraft cockpits.

More precisely, the subject of the invention is an optical device for detecting the position/orientation of a helmet, said device comprising at least one stationary camera associated with an image processing system and a helmet, characterized in that the helmet has a scattering coating and includes at least one set of markers, each marker comprising at least a first optical element having a very low reflection coefficient, a very low scattering coefficient and a very high absorption coefficient in the visible range. Moreover, said device may include at least one additional stationary light source, the first optical element having a very low reflection coefficient, a very low scattering coefficient and a very high absorption coefficient in the emission range of said light source.

Advantageously, the first element is either a black body, i.e. a cavity having a hole, the dimensions of the hole being small compared with the dimensions of the cavity, or it comprises a nickel phosphide film, or else it consists of a carpet of carbon nanotubes.

Advantageously, in a second embodiment, the device includes at least one stationary camera associated with an image processing system and a helmet, characterized in that the helmet includes at least one set of markers, each marker comprising a first optical element having a very high retroreflection coefficient and a very low scattering coefficient in the visible range. As in the previous embodiment, the device may include at least one additional stationary light source.

In this case, the first optical element may be a catadioptric element.

Advantageously, the device includes optomechanical means for producing an image of the light source on the optical axis of the camera.

Advantageously, the marker comprises a second optical element, the second optical element having a high scattering or phosphorescence or fluorescence coefficient in the emission range of the light source, it being possible for the markers of each set of markers to be of different shape and for the second optical element to surround the first optical element.

Finally, the source may emit in the ultraviolet, the second element being phosphorescent or fluorescent in the emission range of said light source.

### BRIEF DESCRIPTION OF THE DRAWINGS

The invention will be better understood and other advantages will become apparent on reading the following description given by way of non-limiting example and thanks to the appended figures in which:

FIG. 1, already commented upon, represents a position detection system according to the prior art;

FIG. 2, already commented upon, represents the signal in the presence and in the absence of stray light in a device according to the prior art;

FIG. 3 represents a first embodiment of a device according to the invention under solar illumination;

FIG. 4 represents the signal in the configuration shown in FIG. 3;

FIG. 5 represents a first embodiment of a device according to the invention under low illumination;

FIG. 6 represents a signal in the configuration shown in FIG. 5;

FIG. 7 represents a first marker according to the invention;

FIG. 8 represents a second embodiment of a device according to the invention under high illumination;

FIG. 9 represents the signal in the configuration shown in FIG. 8 under low illumination;

FIG. 10 represents three examples of catadioptric markers.

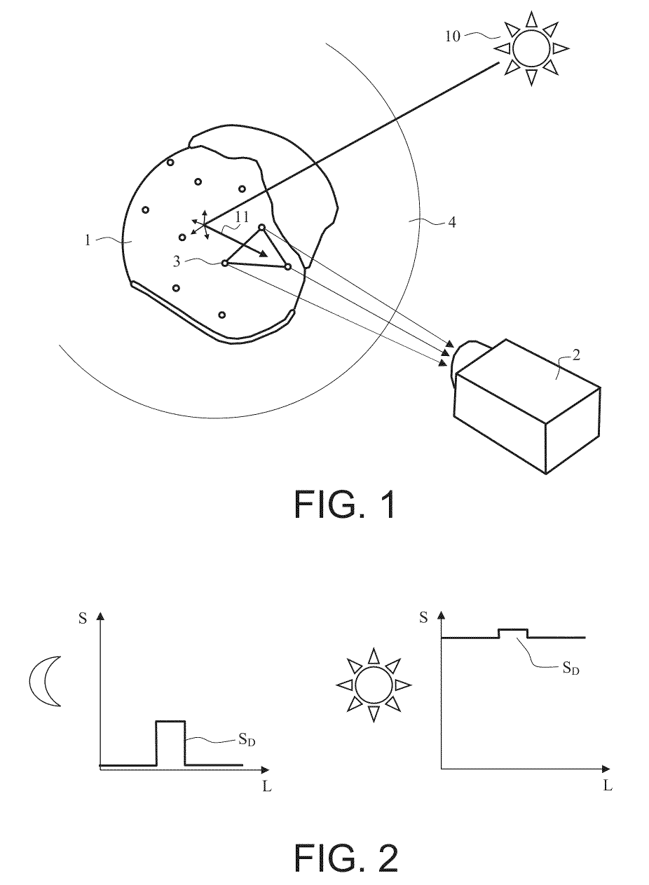

### DETAILED DESCRIPTION

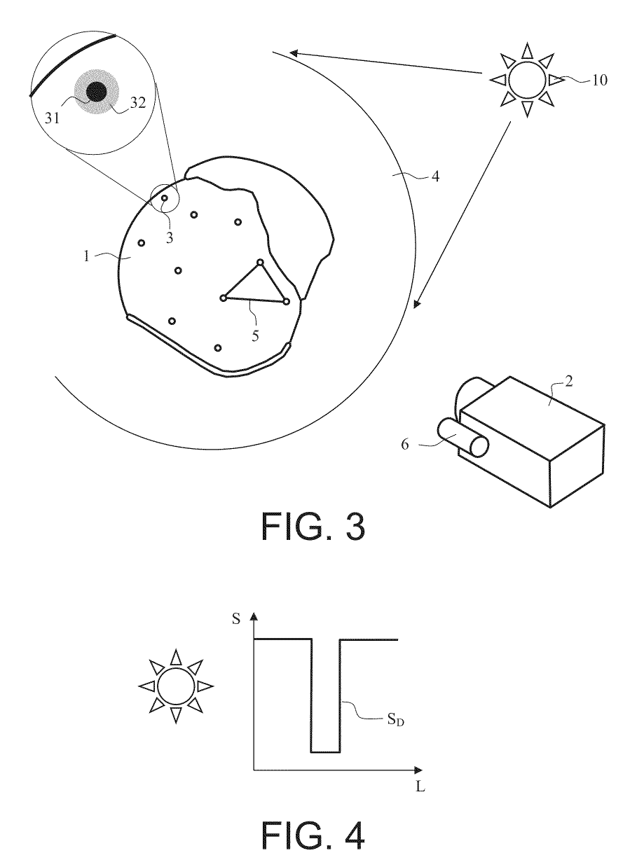

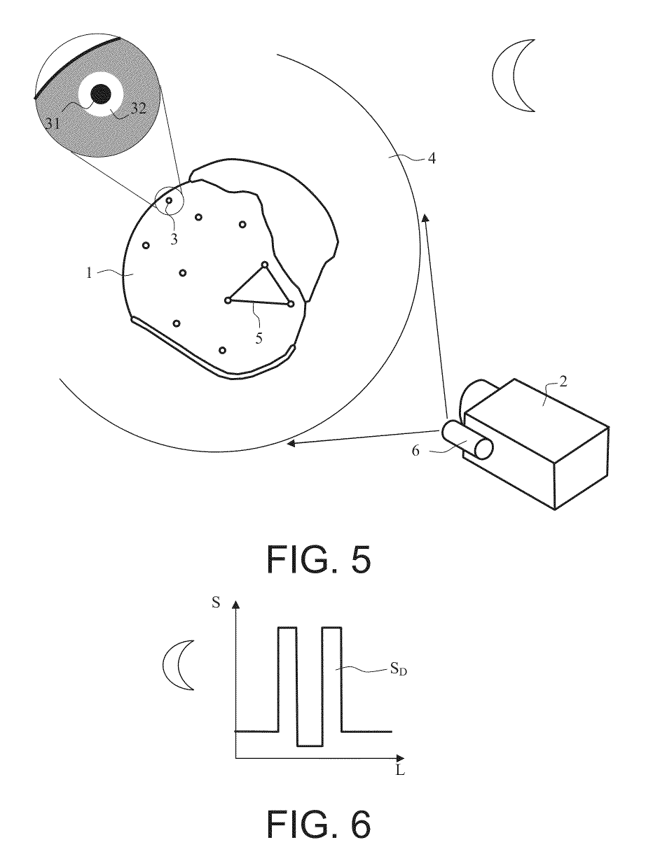

As first exemplary embodiment, a helmet posture detection device is depicted in FIGS. 3 to 7. FIG. 3 represents the device under solar illumination and FIG. 5 represents the same device under low illumination. FIGS. 4 and 6 represent the received signal under low illumination.

As shown in FIGS. 3 and 5, the device comprises a helmet 1 worn by a user who can move in a defined region 4. The device according to the invention is well suited for operating in an aeronautical environment, such as an aircraft cockpit. In this case, the user is a pilot. However, this device may be used for all applications requiring knowledge about the posture of the user's head.

The helmet 1 has a matt scattering coating, advantageously light in colour, and includes a set of markers 3. Each marker 3 is represented by a circle in FIGS. 3 and 5.

For operating at night or under a very low light level, the detection device may also include one or more additional stationary light sources 6 distributed around the cockpit. It is also possible, to avoid employing additional sources, to use cameras that can operate at a very low light level, such as cameras with light intensifiers. These sources are sufficiently numerous to illuminate the entire region 4 in which the helmet can move. In FIGS. 3 and 5, the source 6 is close to the camera 2, but this is not a necessity. These sources 6 may operate within the sensitivity range of the camera. They may also be ultraviolet (UV) radiation sources. In this case, as will be seen, the markers must include fluorescent optical parts that can be detected by the cameras. These sources are preferably light-emitting diodes that have three advantages: they are very compact, they are very robust and they are very reliable.

The markers are detected by a set of cameras 2. For the sake of clarity, only one camera is shown in FIGS. 3 and 5. The cameras are arranged in such a way that, whatever the movements of the user's head, a certain number of markers are always in the field of view of the cameras. In general, it is estimated that three cameras are sufficient. The cameras may be those with CCD (Charge Coupled Device) sensors. The focal length and the aperture of the camera objectives must be chosen to be small enough so that the images of the markers are always sharp on the photosensitive surface. The camera resolution must be adapted to the desired detection precision. The camera sensitivity must be sufficient, so that the images given by the sources can be exploited.

If necessary, these markers have different geometric shapes so as to be able to be easily distinguished. They may be in the form of circles or lines. Their distribution on the helmet forms geometric figures, called “constellations”, which can be easily identified by the image processing system. Thus, in FIGS. 3 and 5, three markers form a triangle 5. The image processing system has not been shown in FIGS. 3 and 5. After calculation, the system enables the posture of the helmet in space to be obtained.

Each marker 3 comprises a first optical element 31 as shown in the blown-up parts of FIGS. 3 and 5. This element has a very low reflection coefficient and a very low scattering coefficient in the visible range and in the range of the light source 6. It also has a very high absorption at these wavelengths. Thus, under high illumination, the contrast between this first optical element 31 and the colour of the helmet is very high and may be easily detected by the cameras. In FIG. 3, the optical element 31 appears black on a white background. FIG. 4 shows the signal S_{D} from this same element under high illumination. As maybe seen, the contrast is excellent and is completely independent of the level of illumination.

Each marker 3 may also include a second optical element 32 as shown in the blown-up parts of FIGS. 3 and 5, the second optical element 32 having a high scattering, fluorescence or phosphorescence coefficient in the emission range of the light source. Thus, at night, or under low illumination, the contrast of the marker is obtained by the phosphorescent border excited by the UV light-emitting diodes near the CCD cameras, which are insensitive to the UV radiation. In FIG. 5, the optical element 32 appears white on the grey background of the helmet. FIG. 6 shows the signal S_{D} from the same element under low illumination. Here again, the contrast is excellent. This method has the advantage of using a light source the radiation of which is absorbed by the glass of the cockpit, making said light undetectable from the outside.

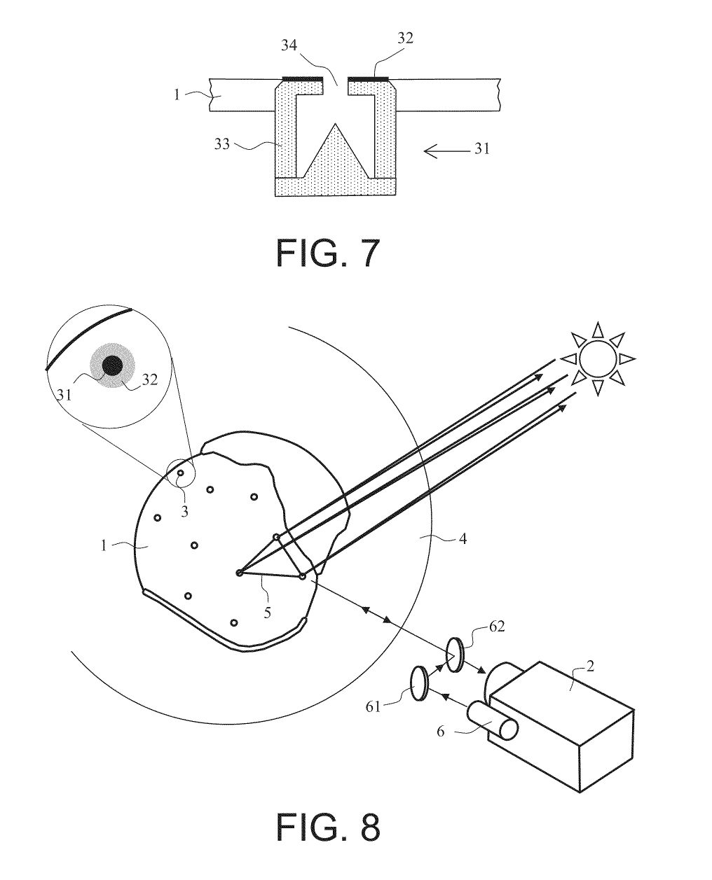

The first element 31 is either a black body, i.e. a cavity 33 having a hole 34 as indicated in the sectional view shown in FIG. 7, the dimensions of the hole being small compared with the dimensions of the cavity, or comprises a nickel phosphide film, or else consists of a carpet of carbon nanotubes. In the first case, the reflection coefficient R of the black body is of the order of 10⁻⁴, while in the second case, the second reflection coefficient R of the nickel phosphide is of the order of 20×10⁻⁴. Finally, the reflection coefficient R of a carpet of carbon nanotubes is of the order of 4×10⁻⁴.

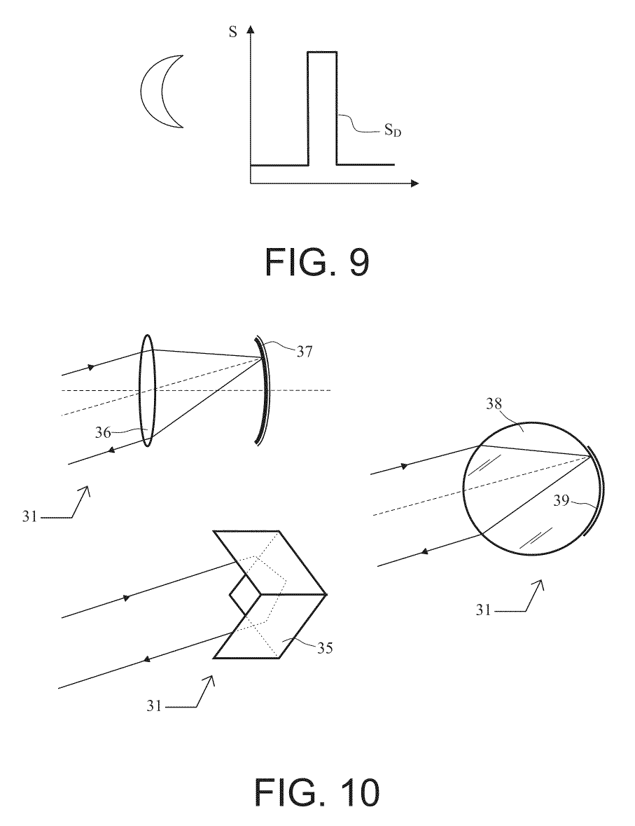

As a second exemplary embodiment, which is a variant of the previous device, a second, helmet posture detection device is depicted in FIGS. 8 to 10. FIG. 8 shows the device under high illumination. FIG. 9 shows the signal received under low illumination and FIG. 10 shows various embodiments of the marker 3.

This second device essential differs from the first embodiment by the operation of the markers. In the present case, each marker 3 comprises a first optical element 31 of the “catadioptric” type, having a very high retroreflection coefficient and a very low scattering coefficient in the visible range. Thus, the solar radiation is necessarily reflected in the sun's direction, as may be seen in FIG. 8, and cannot reach the cameras. In the daytime, the operation is therefore identical to that of the previous device.

The term “catadioptric” refers to any optical reflector or retroreflector having the property reflecting a light beam in the same direction as its incident direction. To give an example, a “cube corner” reflector formed from three mutually orthogonal plane mirrors is a catadioptric reflector. Thus, a light beam emitted by the emitting part and illuminating the catadioptric reflector is re-emitted in the same direction towards the receiving part with an excellent efficiency. Likewise, any light beam which does not emanate from the source and which strikes the catadioptric reflector produces, in principle, virtually no illumination towards the receiving part.

A catadioptric reflector may constitute, as indicated in FIG. 10:

a cube corner reflector, that is to say an assembly of three plane mirrors 35 that are mutually perpendicular;

a simple lens 36 and a reflecting mirror 37 placed on the focal surface of this lens;

a transparent sphere 38, with an optical index of 2, also called a “cat's eye”, the rear face 39 of said sphere being reflective.

It is also possible to use phase conjugate mirrors.

All these devices have the particular feature of reflecting any light ray in the same direction as its direction of incidence.

At night or under a very low light level, if the sensitivity of the cameras is no longer sufficient, it is possible to use additional light sources. In this case, there are two possible operating modes dependent on the position of the light source relative to the camera. In a first embodiment, the light source is not on the optical axis of the camera. In this case, the radiation from the source illuminating the catadioptric reflector is reflected back to the source, and the camera receives no illumination coming from the catadioptric reflector. The catadioptric reflector appears black on a light background. It is then advantageous for the marker to include a second optical element 32 having a high diffusion or phosphorescence coefficient in the emission range of the light source or for the coating on the helmet to be light in colour on the periphery of the catadioptric reflector.

In the second embodiment shown in FIG. 8, the device includes optomechanical means of producing an image of the light source on the optical axis of the camera. In the case of FIG. 8, these means are simply a mirror 61 and a semireflecting plate 62 for mixing the two, source and camera, channels. In this case, the radiation from the source illuminating the catadioptric reflector is sent back to the camera. The catadioptric reflector appears bright on a dark background, as shown in FIG. 9. It no longer necessary for the marker 3 to include a second optical element 32. Advantageously, the helmet coating is of dark colour on the periphery of the catadioptric reflector.

To improve the detection, it is possible to make a number of modifications to the general arrangements described above. Thus, the light source, when it is present, will be turned off when the sunshine conditions are sufficient; it may be modulated temporally; it may be a scanning light source; it may be controlled so as to illuminate particular areas of the helmet.

What is claimed is:

1. An optical device for detecting the position/orientation of a helmet, said device comprising at least one stationary camera associated with an image processing system and a helmet, wherein the helmet has a scattering coating and includes at least one set of markers, each marker comprising at least a first optical element having a very low reflection coefficient, a very low scattering coefficient and a very high absorption coefficient in the visible range, the reflection coefficient being less than or equal to 0.002.

2. The optical device for detecting the position/orientation of a helmet according to claim 1, wherein the said device further comprises at least one stationary light source, the first optical element having a very low reflection coefficient, a very low scattering coefficient and a very high absorption coefficient in the emission range of said source.

3. The optical device for detecting the position/orientation of a helmet according to claim 1, wherein the first element is a black body that is a cavity having a hole, the dimensions of the hole being small compared with the dimensions of the cavity.

4. The optical device for detecting the position/orientation of a helmet according to claim 1, wherein the first element comprises a nickel phosphide film.

5. The optical device for detecting the position/orientation of a helmet according to claim 1, wherein the first element consists of a carpet of carbon nanotubes.
